(19) United States
(12) Patent Application Publication
(10) Pub. No.: US 2022/0063751 A1
(43) Pub. Date: Mar. 3, 2022

(54) ELECTRIC UNICYCLE WITH MANUAL CONTROL

(71) Applicants: Jing Yuan Zhou, Richmond (CA); JiHua JiHua, Richmond (CA)

(72) Inventors: JING YUAN ZHOU, RICHMOND, BC (CA); JiHua Zhou, Richmond, BC (CA)

(21) Appl. No.: 17/276,018

(22) PCT Filed: Aug. 2, 2019
(86) PCT No.: PCT/CA2019/051063

§ 371 Date: Mar. 12, 2021

(30) Foreign Application Priority Data
Sep. 13, 2018 (CA) 3017295

(51) Int. Cl. B62K 11/00; B62K 1/00; B62M 6/45; B62M 6/90; B62M 6/55; B62K 23/08; B62J 1/02; B62K 21/12; B62L 3/04; B62J 45/20

(52) U.S. Cl. CPC B62K 11/007; B62K 1/00; B62M 6/45; B62M 6/90; B62J 45/20; B62K 23/08; B62J 1/02; B62K 21/125; B62L 3/04; B62M 6/55

(57) ABSTRACT

This invention is an electric unicycle. It is an improvement of a unicycle and a self-balancing electric unicycle. It comprises one wheel (1B), brushless DC motor (1C), operating-pedal (1D), seat (2A), pneumatic springs (2B) for shock absorb, mainboard (1F), lithium-ion battery pack (1G), telescopic handle (1I), emergency brake footboard (1J), casing (1H). The emergency brake footboard (1J) can be easily mounted and unmounted and folded. While in using, the user generally rides on the seat, swings their foot, to adjust the depression angle of the operating-pedal (1D), to control the wheel rotation, rather than by an electric gyro. Thus, this invention is easy to operate, easy to learn, easy to use, flexible, portable, zero emission, great trafficability. It will become the main short-distance means of transportation for cities and villages, and even can be used in poor road conditions, such as field exploration and forest patrol.

### TECHNICAL FIELD

This invention is an improvement of a unicycle and a self-balancing electric unicycle. Users swings their foot, to control the wheel advance or retreat, for driving it. It is a means of transportation.

### TECHNICAL BACKGROUND

A conventional unicycle, riding it is a sport that often appears in acrobatics. Riding it requires some special skills and much training. It is difficult to operate for ordinary people. Therefore, conventional unicycles have not become a common means of transportation, maybe never be.

In the past two decades, with the advancement of battery, electric motor and microelectronics technology, people have improved conventional unicycle, installed motor, powered by batteries, enhanced its stability by electronic gyro, and invented self-balancing electric unicycle. Due to the limitation of the electronic gyro, the user must keep a certain posture when riding. For example, the “Ninebot One” electric unicycle, users must usually stand upright. That is easy to fatigue, not suitable for long driving, not suitable as a transportation, just a kind of “cool” toy.

This invention aims to turn a unicycle into a practical and common means of transportation.

### Contents of this Invention

This invention is very similar to a self-balancing electric unicycle, but its operating principle is quite different. A self-balancing electric unicycle, its electric gyro senses its posture (angle of depression or elevation) and controls the driving force of its wheel. Its user controls the driving force of the wheel by adjusting its posture, to realize the user's will. Adjusting its posture needs the user's physical coordination. However, this invention, its user swings their foot to control the driving force of the wheel, according to their will and their posture. The concept of this invention is based the following knowledge: 1) human beings have a good ability to perceive their postures; 2) their foot is more flexible and easier to train than their body; 3) their sitting posture is less fatigue than their standing; 4) their variable posture is less fatigue than their a fixed posture.

Referring to FIG. 1 and FIG. 2, this electric unicycle will be described below:

This electric unicycle comprises a wheel (1B), a brushless DC motor (1C), two different pedals (1D, 1K), a seat assembly (1E), a mainboard (1F), and a lithium-ion battery pack (1G), casing (1H).

The wheel (1B), the brushless DC motor (1C), and the lithium-ion battery pack (1G) are similar to those of a self-balancing electric unicycle or an electric bicycle, and are even interchangeable.

The two different pedals, which are unique to this invention. Before using, the basic depression angles of the two pedals can be adjusted according to the user's preferences and feelings, and then locked. The two pedals, expand when using, or fold when not using. When a user is driving this electric unicycle, the two pedals are different: one is fixed-pedal (1K), it is only for supporting the foot and its depression angle has been fixed; the other one is operating-pedal (1D), its depression angle is variable, and the user swings the foot, to adjust its depression angle, to operate the wheel speed and direction of rotation. Like this, the user controls the wheel rotation speed and direction with the foot to maintain the traveling and the pitch balance, and while the traveling, twists the wheel left and right to maintain their left and right balance.—This principle comes from a conventional unicycle.

In order for the user easy to operate, the following functions of operating-pedal is set: After turn on the power, when the user's foot is in the middle position or does not touch the operating-pedal, the wheel is locked by the limited electromagnetic force and cannot be easily rotated; When the user swings the foot and increases the depression angle of the operating-pedal, the wheel turns forward, and the greater the depression angle of the operating-pedal, the faster the rotation of the wheel is; when the user swings the foot and reduces the depression angle of the operating-pedal, the wheel decreases forward rotation, even reverses; while the user swinging the foot to control the operating-pedal, the speed of the rotation of the wheel is continuously variable.

Since a unicycle and an electric bicycle are very different, if people is to limit the speed of an electric bicycle, just limit the motor speed; but people cannot do so on a unicycle. Otherwise, when the unicycle reaches the speed limit, the user will immediately fall down. When driving a unicycle normally, if the user wants to accelerate, the user first reduce the wheel speed slightly, then the center of gravity will be ahead of the ground fulcrum, then the user feels the trend of falling forward, then the user accelerates the wheel forward to catch up the acceleration of the falling forward, so the user will achieve the accelerating and pitch balance. Similarly, if the user wants to decelerate, the user first increases the wheel speed slightly, then the center of gravity will be behind of the ground fulcrum, then the user feels the trend of falling backward, then the user decelerates the wheel speed to catch up the acceleration of the falling backward, so the user will achieve the decelerating and pitch balance. A cyclist of a unicycle may not know these theoretical details, but they all instinctively do so. The training has given the cyclist this instinctive response. This electric unicycle takes full advantage of this instinctive response. In order to make users easier to operate and safer, the operating-pedal of this electric unicycle has two-stage of “foot feeling”: when this electric unicycle is traveling normally, the “foot feeling” is normal, this is the normal stage; when this electric unicycle reaches the speed limit or approaches the torque limit, the operating force of the user's foot is abrupt changed, this “foot feeling” is the extreme stage, to remind the user, then the user will automatically respond and limit the excessive operating.

The speed limit of this electric unicycle is determined by the user's preference, local law, the power situation, and road condition (such as a large uphill). The mainboard analyzes and determines it, which is reflected in the “foot feeling”. Under normal circumstances, on a flat and hard road, the torque is limited to the maximum torque of the motor. However, in a slippery road, in order to avoid falling caused by wheel slip, this electric unicycle will limit the torque according to the user's setting. While the torque of the wheel approaches the limit torque, the user will get a “foot feeling” of warning, to avoid a sudden acceleration or deceleration.

To achieve the above functions, the mainboard must be well designed and manufactured. The mainboard can be designed and manufactured by current technology. In addition, the mainboard also includes an intelligent system and a Bluetooth function, to connect with a smart device (such as a smart phone) carried by the user, to realize the following functions: 1) The user's smart device will become a smart key with anti-theft function. 2) The user can set the speed limit and the wheel torque limit on their smart device to suit his preferences, local laws, and road condition. 3) This electric unicycle transmits the speed information in real time, and the user intelligent device displays the speed and accumulated mileage; this electric unicycle transmits the remained power of the lithium ion battery pack in real time and displays it on the user smart device, so that the user can plan the trip easily.

The seat assembly (1E) includes a seat (2A), two pneumatic springs (2B) for shock absorbing, and two hinges (2D) for folding the pedals. When this electric unicycle is traveling, its user generally operates in sitting position. Its user can sit upright on the seat or sit bent forward on the seat. In order to adapt to high-speed driving and bumpy roads, the seat is supported by springs, preferably pneumatic springs (2B), to cushion the ground impact and to make its user more comfortable. Its user can adjust the stiffness of the pneumatic springs according to his or her weight and preference.

This electric unicycle can be equipped with a telescopic handle (1I). The telescopic length has several gear positions. When inconvenient to ride or no power, then turn off the power, the wheel is unlocked and can freely rotate, its user can easily drag it with the wheel or lift it, by the handle. This is very convenient for its user. Moreover, when riding, raising the handle, the navigation device, the portable electronic device can fix on the handle, for navigation, display the speed, and display the remained power, etc. The handle can also be an armrest of its user while driving.

An operating-handle can be added to this electric unicycle, for taking the place of the operating-pedal, when doing complex movements such as riding jumps, or its user has one disabled leg. Its user swings the hand to manipulate the operating-handle is similar to manipulate the operating-pedal. Accordingly, we reserve a position at the telescopic handle (1I) to fix the operating-handle.

We can install an emergency brake footboard (1J) for this electric unicycle. While riding conventional unicycles, such as unicycles, self-balancing electric unicycles, the cyclists have difficulty in emergency braking, and can only brake slowly. The main reason is that unicycles cannot have wheel slippage or wheel locks. Otherwise, they will lose control and fall. While traveling, the emergency brake footboard is a cantilever of the rear of this electric unicycle. While emergency braking, its user stands up, one foot steps on the operating-pedal, the other foot steps on the emergency brake footboard, which is stepped to the ground, then the emergency brake footboard slides along the ground, quickly consuming the kinetic energy as well as sudden braking. In this way, the user's feet in tandem can ensure balance front and rear, balance left and right, and even adjust the driving direction while braking. This electric unicycle is portable and convenient, and the emergency brake footboard can be quickly mounted and unmounted, or can be folded upward.

The casing (1H), is for assembling the above components together, protecting the fragile components, and blocking the user from touching the moving parts (such as wheels). The blocking the user from touching the 110 moving parts is a safety consideration.

### Advantages of this Invention

Comparing with a conventional unicycle, this electric unicycle uses a brushless DC motor instead of the pedal-crank mechanism of the conventional unicycle. This electric unicycle is powerful, and the user can have a lower center of gravity. Thus, using of it, is more labor-saving, more stable, easier to operate, and even users can free their two hands. If user fall, it is easy to touch the ground with their two hands, that will be safer.

This electric unicycle, compared with the current self-balancing electric unicycle, it has no electric gyro that a self-balancing electric unicycle has. The user controls the rotation speed and direction of its wheel by the foot, rather than an electric gyro. The user can drive it with sitting, standing, oblique sitting, stooping sitting, stooping standing, or other postures. The user can also change their posture arbitrarily, and much easier. Moreover, normally, the user drives this electric unicycle in a sitting posture, with low center of gravity, free two hands, not easy to fatigue, and is safer. This electric unicycle, its size, weight, manufacturing technology, and manufacturing cost are near to a self-balancing electric unicycle.

This electric unicycle, compared with a conventional bicycle, it has the following advantages: its power is stronger; the center of gravity of its user is lower; more stable; its user's hands are free; its trafficability is better, it can pass through almost any poor road that a person can walk through, such as forest roads, fields, etc.; it is small, convenient, and its size is about an ordinary medium-sized suitcase.

The above comparison shows: this invention is easy to control (user only moving their foot), powerful (electrically driven), low center of gravity (lower than a bicycle or a self-balancing electric unicycle), better stability, easy to operate (similar to a conventional bicycle), compact and portable (can be placed in a trunk), good trafficability (almost all roads that people can walk through, even walk through forest roads, fields), speed can be fast or slow (reference self-balancing electric unicycle, speed up to 120 km/h, we can speed limit at 16 km/h), both hands free when riding, safer than normal bicycles (not easy to fall), zero emissions, no pollution. This electric unicycle is expected to become the main short-distance means of transportation in cities and villages, and can even be used for poor road conditions such as field exploration and forest patrol.

### DESCRIPTION OF DRAWINGS

FIG. 1 the general view and back view of this electric unicycle (1A)

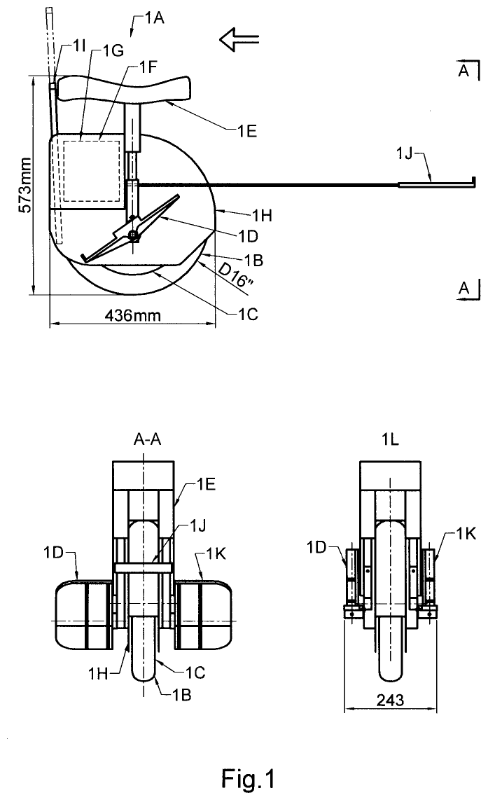

FIG. 2 the seat assembly (1E)

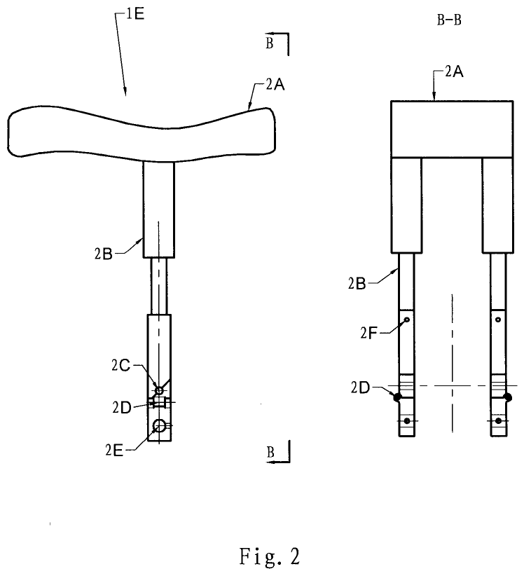

FIG. 3 the drawing for the abstract

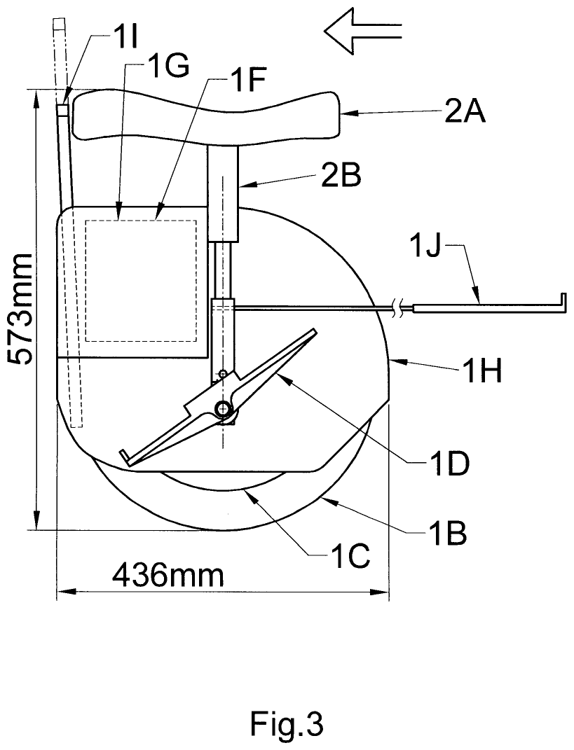

The above drawings show only one example of this invention. Unit: mm

The meaning of symbol in drawings:

| Symbol | Meaning | Remarks |
|---|---|---|
| 1K | fixed-pedal | |
| 1L | While the pedals folded up | |
| 2A | Seat | |
| 2B | Pneumatic spring | For shock absorb |
| 2C | Shaft hole | For fixing the wheel |
| 2D | Hinge | For folding up pedal |
| 2E | Axis hole | For installing pedal |
| 2F | Hole | For installing the emergency |
| | | brake footboard |

| Symbol | Meaning | Remarks |
|---|---|---|
| 1A | This electric unicycle | |
| 1B | Wheel | |
| 1C | Brushless DC motor | Or BLDC motor |
| 1D | operating-pedal | |
| 1E | Seat assembly | |
| 1F | Mainboard | |
| 1G | Lithium-ion battery pack | |
| 1H | Casing | |
| 1I | Telescopic handle | |
| 1J | Emergency brake footboard | For emergency brake |

1. An electric unicycle is an improvement of a conventional unicycle and a self-balance electric unicycle. It comprises:
1) One wheel;
2) One brushless DC motor, to drive the wheel to rotate;
3) Two pedals, which pitch angle can be adjusted and locked according to user's feelings and preferences. Among them,
One is a fixed-pedal, only for supporting user's foot;
The other one is an operating-pedal, for the user swings the foot to control the speed and direction of the wheel rotation.
4) One seat;
5) Mainboard, to control the brushless DC motor according to the signal of the operating-pedal;
6) Lithium-ion battery pack;
7) One casing.

2. The electric unicycle said in claim 1, wherein the operating-pedal, after the power is turned on,
1) When the user's foot is in the middle position, or not in operation, the wheel is locked by limited electromagnetic force and not easy to be rotated;
2) When the user swings the foot and increases the depression angle of the operating-pedal, the wheel turns forward;
3) When the user swings the foot and reduces the depression angle of the operating-pedal, the wheel reduces the forward rotation speed, and even reverse;
4) While the user swinging the foot to manipulate the operating-pedal, the wheel rotation speed is continuously variable.

3. The electric unicycle said in claim 1, wherein the operating-pedal, has two stages of “foot feeling”, the normal stage and the extreme stage:
1) Normal stage, when the electric unicycle is driving normally;
2) Extreme stage, when the electric unicycle reaches the speed limit or approach the torque limit, the user's foot manipulation force is abrupt changed, for reminding the user to limit the excessive manipulation.

4. The electric unicycle said in claim 1, wherein the mainboard further comprises an intelligent system and a Bluetooth function, to connect to the user's smart device (such as a smart phone):
1) The user's smart device can be the smart key for this electric unicycle with anti-theft function.
2) The user can set the speed limit, and set the wheel torque limit to fit on slippery ground, on their smart devices.
3) The electric unicycle sends information to the user's smart device in real time:
Send speed information, the user's smart device can display its speed and accumulated mileage;
Send the remained power of the lithium-ion battery pack, so that the user can plan the trip better.

5. The electric unicycle said in claim 1, wherein the seat is supported by pneumatic springs to accommodate high-speed driving and roads bumping.

6. The electric unicycle said in claim 1, which can be equipped with a telescopic handle (1I), the telescopic length has several gear positions: when inconvenient to ride or no power, the user can easily drag with the wheel or carry, by the handle; convenient to fix some auxiliary equipment on the handle; the handle can be as an armrest for the user while driving.

7. The electric unicycle said in claim 1, wherein an operating-handle can be added, to replace the operating-pedal, when performing complicated movements such as riding jumps or the user has one disabled leg. The user swings the hand to perform the manipulation in a manner similar to the manipulation of the operating-pedal.

8. The electric unicycle said in claim 1, wherein an emergency brake footboard is added.
